(19) United States
(12) Patent Application Publication
(10) Pub. No.: US 2025/0031200 A1
(43) Pub. Date: Jan. 23, 2025

(54) Systems and Methods for Traffic Management

(71) Applicant: Comcast Cable Communications, LLC, Philadelphia, PA (US)

(72) Inventors: Ivan Ong, Malvern, PA (US); Kenneth Egan, Austin, TX (US)

(21) Appl. No.: 18/223,353

(22) Filed: Jul. 18, 2023

(51) Int. Cl. H04W 72/12; H04W 72/542

(52) U.S. Cl. CPC H04W 72/1215; H04W 72/542; H04W 88/10

(57) ABSTRACT

Systems, apparatuses, and methods are described for optimization of Packet Traffic Arbitration mechanisms. Enabling intelligent packet traffic arbitration may comprise allocating network resources based on various criteria for transmissions across overlapping channels. These criteria may be weighted to determine whether to enable arbitration mechanisms to prioritize the lower-power transmissions while avoiding latency in the higher-power transmissions.

### BACKGROUND

Devices connected to gateways may transmit across multiple frequencies. Some devices such as motion sensors transmit data via comparatively low-power, lower-bandwidth wireless protocols (e.g., ZigBee, Matter, Bluetooth, etc.). Transmissions across busy channels via such protocols may be unable to jump to other channels. For example, lower-power wireless protocol transmissions over channels busy with traffic having higher bandwidth and transmission power (e.g., WiFi, etc.) may get delayed. Notifications from security devices such as motion sensors, door sensors, window sensors, and/or other devices may get delayed, for example, if the transmission occurs during a time of high WiFi traffic (e.g., in the evening when multiple household members are home and using various internet-connected devices). Implementation of packet traffic arbitration may prioritize the lower-power transmissions, for example, at the cost of silencing the higher-power transmissions such as WiFi, which may result in latency.

### SUMMARY

The following is a simplified summary of certain features of the disclosure. The summary is not an extensive overview and is not intended to identify key or critical elements.

Systems, apparatuses, and methods are described for the optimization of Packet Traffic Arbitration (PTA). Enabling packet traffic arbitration may prioritize lower-power, lower-bandwidth transmissions by allocating or reallocating network resources such as bandwidth for these transmissions, for example, from higher-power, higher-bandwidth transmissions. Intelligent packet traffic arbitration may comprise allocating transmission resources based on various criteria for various devices transmitting across the same channels. These criteria may be weighted to determine whether to enable packet traffic arbitration for optimal performance of connected devices (e.g., to optimize the lower-power transmissions while avoiding latency in the higher-power transmissions). The criteria may include, but is not limited to, device properties, transmission conditions, amount of retries, queue sizes, signal-to-noise ratios (SNR), schedules, device types, user profiles, etc. These and other features and advantages are described in greater detail below.

### BRIEF DESCRIPTION OF THE DRAWINGS

Some features are shown by way of example, and not by limitation, in the accompanying drawings. In the drawings, like numerals reference similar elements.

FIG. 1 shows an example communication network.

FIG. 2 shows hardware elements of a computing device.

FIG. 3 shows an environment with example device types transmitting over various wireless protocols.

FIGS. 4A-4C are tables showing example results of enabling intelligent packet traffic arbitration.

FIG. 5 is a table showing example criteria for enabling packet traffic arbitration.

FIG. 6A is a table showing example criteria for enabling packet traffic arbitration based on devices.

FIG. 6B is a flow chart showing an example method for packet traffic arbitration based on devices.

FIG. 7A is a table showing example criteria for enabling packet traffic arbitration based on schedules.

FIG. 7B is a flow chart showing an example method for packet traffic arbitration based on schedules.

FIG. 8A is a table showing example criteria for enabling packet traffic arbitration based on user profiles.

FIG. 8B is a flow chart showing an example method for packet traffic arbitration based on user profiles.

FIG. 9 is a flow chart showing an example method for intelligent packet traffic arbitration.

FIG. 10 is a flow chart showing an example method for intelligent packet traffic arbitration.

FIG. 11 is a flow chart showing an example method for intelligent packet traffic arbitration.

FIG. 12 is a sequence diagram showing example communications between a gateway and devices using various wireless protocols.

FIG. 13 is a sequence diagram showing example communications between a gateway and devices using various wireless protocols.

### DETAILED DESCRIPTION

The accompanying drawings, which form a part hereof, show examples of the disclosure. It is to be understood that the examples shown in the drawings and/or discussed herein are non-exclusive and that there are other examples of how the disclosure may be practiced.

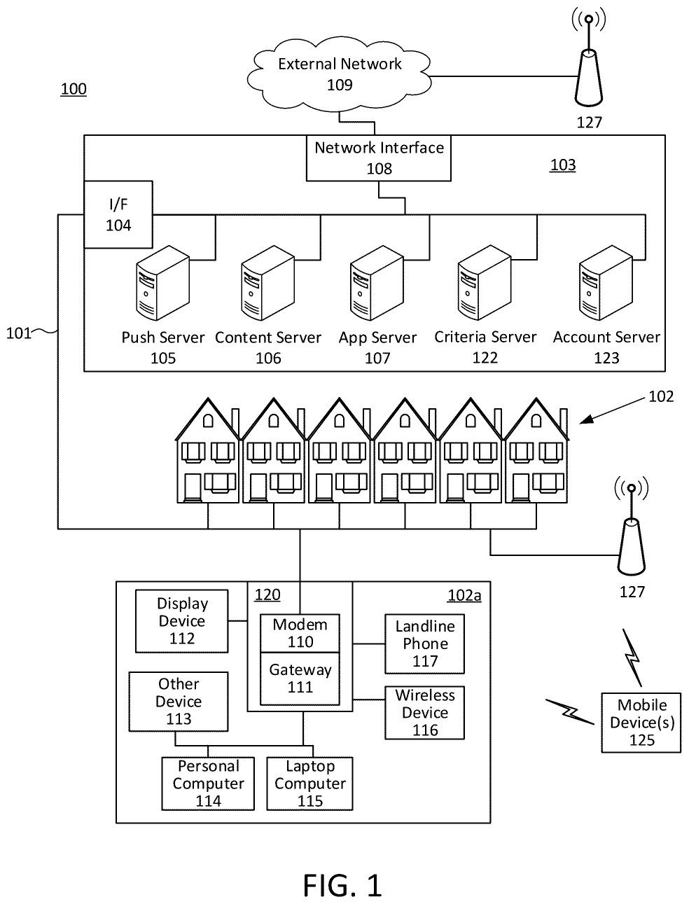

FIG. 1 shows an example communication network 100 in which features described herein may be implemented. The communication network 100 may comprise one or more information distribution networks of any type, such as, without limitation, a telephone network, a wireless network (e.g., an LTE network, a 5G network, a WiFi IEEE 802.11 network, a WiMAX network, a satellite network, and/or any other network for wireless communication), an optical fiber network, a coaxial cable network, and/or a hybrid fiber/coax distribution network. The communication network 100 may use a series of interconnected communication links 101 (e.g., coaxial cables, optical fibers, wireless links, etc.) to connect multiple premises 102 (e.g., businesses, homes, consumer dwellings, train stations, airports, etc.) to a local office 103 (e.g., a headend). The local office 103 may send downstream information signals and receive upstream information signals via the communication links 101. Each of the premises 102 may comprise devices, described below, to receive, send, and/or otherwise process those signals and information contained therein.

The communication links 101 may originate from the local office 103 and may comprise components not shown, such as splitters, filters, amplifiers, etc., to help convey signals clearly. The communication links 101 may be coupled to one or more wireless access points 127 configured to communicate with one or more mobile devices 125 via one or more wireless networks. The mobile devices 125 may comprise smart phones, tablets or laptop computers with wireless transceivers, tablets or laptop computers communicatively coupled to other devices with wireless transceivers, and/or any other type of device configured to communicate via a wireless network.

The local office 103 may comprise an interface 104. The interface 104 may comprise one or more computing devices configured to send information downstream to, and to receive information upstream from, devices communicating with the local office 103 via the communications links 101. The interface 104 may be configured to manage communications among those devices, to manage communications between those devices and backend devices such as servers 105-107 and 122-123 and/or to manage communications between those devices and one or more external networks 109. The interface 104 may, for example, comprise one or more routers, one or more base stations, one or more optical line terminals (OLTs), one or more termination systems (e.g., a modular cable modem termination system (M-CMTS) or an integrated cable modem termination system (I-CMTS)), one or more digital subscriber line access modules (DSLAMs), and/or any other computing device(s). The local office 103 may comprise one or more network interfaces 108 that comprise circuitry needed to communicate via the external networks 109. The external networks 109 may comprise networks of Internet devices, telephone networks, wireless networks, wired networks, fiber optic networks, and/or any other desired network. The local office 103 may also or alternatively communicate with the mobile devices 125 via the interface 108 and one or more of the external networks 109, e.g., via one or more of the wireless access points 127.

The push notification server 105 may be configured to generate push notifications to deliver information to devices in the premises 102 and/or to the mobile devices 125. The content server 106 may be configured to provide content to devices in the premises 102 and/or to the mobile devices 125. This content may comprise, for example, video, audio, text, web pages, images, files, etc. The content server 106 (or, alternatively, an authentication server) may comprise software to validate user identities and entitlements, to locate and retrieve requested content, and/or to initiate delivery (e.g., streaming) of the content. The application server 107 may be configured to offer any desired service. For example, an application server may be responsible for collecting, and generating a download of, information for electronic program guide listings. Another application server may be responsible for monitoring user viewing habits and collecting information from that monitoring for use in selecting advertisements. Yet another application server may be responsible for formatting and inserting advertisements in a video stream being transmitted to devices in the premises 102 and/or to the mobile devices 125. The local office 103 may comprise additional servers, such as the criteria server 122 and the account server 123 (described below), additional push, content, and/or application servers, and/or other types of servers.

The criteria server 122 may be configured to store criteria for determining whether to enable packet traffic arbitration (PTA). The criteria may include device properties, transmission conditions, amount of retries, queue sizes, signal-to-noise ratios (SNR), schedules, device types, user profiles, etc. The criteria server 122 may store measurements of the criteria, which may be variable. The criteria may be weighted (e.g., using machine learning algorithms) in determining whether to enable PTA (further described below). The account server 123 may be configured to store user and/or device account data. Account data may comprise user information, device characteristics, priority profiles (e.g., indicating which users and/or devices may be prioritized in determining whether to enable PTA).

Although shown separately, the push server 105, the content server 106, the application server 107, the criteria server 122, the account server 123, and/or other server(s) may be combined. The servers 105, 106, 107, 122, and 123, and/or other servers, may be computing devices and may comprise memory storing data and also storing computer executable instructions that, when executed by one or more processors, cause the server(s) to perform steps described herein.

An example premises 102a may comprise an interface 120. The interface 120 may comprise circuitry used to communicate via the communication links 101. The interface 120 may comprise a modem 110, which may comprise transmitters and receivers used to communicate via the communication links 101 with the local office 103. The modem 110 may comprise, for example, a coaxial cable modem (for coaxial cable lines of the communication links 101), a fiber interface node (for fiber optic lines of the communication links 101), twisted-pair telephone modem, a wireless transceiver, and/or any other desired modem device. One modem is shown in FIG. 1, but a plurality of modems operating in parallel may be implemented within the interface 120. The interface 120 may comprise a gateway 111. The modem 110 may be connected to, or be a part of, the gateway 111. The gateway 111 may be a computing device that communicates with the modem(s) 110 to allow one or more other devices in the premises 102a to communicate with the local office 103 and/or with other devices beyond the local office 103 (e.g., via the local office 103 and the external network(s) 109). The gateway 111 may comprise a set-top box (STB), digital video recorder (DVR), a digital transport adapter (DTA), a computer server, and/or any other desired computing device.

The gateway 111 may also comprise one or more local network interfaces to communicate, via one or more local networks, with devices in the premises 102a. Such devices may comprise, e.g., display devices 112 (e.g., televisions), other devices 113 (e.g., a DVR or STB), personal computers 114, laptop computers 115, wireless devices 116 (e.g., wireless routers, wireless laptops, notebooks, tablets and netbooks, cordless phones (e.g., Digital Enhanced Cordless Telephone—DECT phones), mobile phones, mobile televisions, personal digital assistants (PDA)), landline phones 117 (e.g., Voice over Internet Protocol-VoIP phones), and any other desired devices. Example types of local networks comprise Multimedia Over Coax Alliance (MoCA) networks, Ethernet networks, networks communicating via Universal Serial Bus (USB) interfaces, wireless networks (e.g., IEEE 802.11, IEEE 802.15, Bluetooth), networks communicating via in-premises power lines, and others. The lines connecting the interface 120 with the other devices in the premises 102a may represent wired or wireless connections, as may be appropriate for the type of local network used. One or more of the devices at the premises 102a may be configured to provide wireless communications channels (e.g., IEEE 802.11 channels) to communicate with one or more of the mobile devices 125, which may be on- or off-premises.

The mobile devices 125, one or more of the devices in the premises 102a, and/or other devices may receive, store, output, and/or otherwise use assets. An asset may comprise a video, a game, one or more images, software, audio, text, webpage(s), and/or other content.

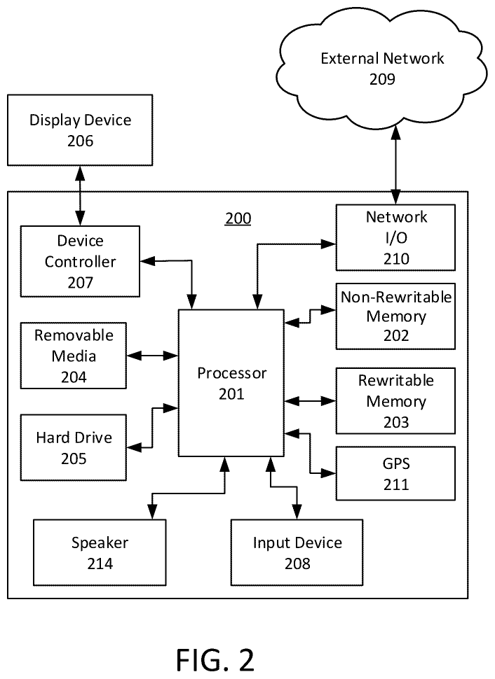

FIG. 2 shows hardware elements of a computing device 200 that may be used to implement any of the computing devices shown in FIG. 1 (e.g., the mobile devices 125, any of the devices shown in the premises 102a, any of the devices shown in the local office 103, any of the wireless access points 127, any devices with the external network 109) and any other computing devices discussed herein. The computing device 200 may comprise one or more processors 201, which may execute instructions of a computer program to perform any of the functions described herein. The instructions may be stored in a non-rewritable memory 202 such as a read-only memory (ROM), a rewritable memory 203 such as random access memory (RAM) and/or flash memory, removable media 204 (e.g., a USB drive, a compact disk (CD), a digital versatile disk (DVD)), and/or in any other type of computer-readable storage medium or memory. Instructions may also be stored in an attached (or internal) hard drive 205 or other types of storage media. The computing device 200 may comprise one or more output devices, such as a display device 206 (e.g., an external television and/or other external or internal display device) and a speaker 214, and may comprise one or more output device controllers 207, such as a video processor or a controller for an infra-red or BLUETOOTH transceiver. One or more user input devices 208 may comprise a remote control, a keyboard, a mouse, a touch screen (which may be integrated with the display device 206), microphone, etc. The computing device 200 may also comprise one or more network interfaces, such as a network input/output (I/O) interface 210 (e.g., a network card) to communicate with an external network 209. The network I/O interface 210 may be a wired interface (e.g., electrical, RF (via coax), optical (via fiber)), a wireless interface, or a combination of the two. The network I/O interface 210 may comprise a modem configured to communicate via the external network 209. The external network 209 may comprise the communication links 101 discussed above, the external network 109, an in-home network, a network provider's wireless, coaxial, fiber, or hybrid fiber/coaxial distribution system (e.g., a DOCSIS network), or any other desired network. The computing device 200 may comprise a location-detecting device, such as a global positioning system (GPS) microprocessor 211, which may be configured to receive and process global positioning signals and determine, with possible assistance from an external server and antenna, a geographic position of the computing device 200.

Although FIG. 2 shows an example hardware configuration, one or more of the elements of the computing device 200 may be implemented as software or a combination of hardware and software. Modifications may be made to add, remove, combine, divide, etc. components of the computing device 200. Additionally, the elements shown in FIG. 2 may be implemented using basic computing devices and components that have been configured to perform operations such as are described herein. For example, a memory of the computing device 200 may store computer-executable instructions that, when executed by the processor 201 and/or one or more other processors of the computing device 200, cause the computing device 200 to perform one, some, or all of the operations described herein. Such memory and processor(s) may also or alternatively be implemented through one or more Integrated Circuits (ICs). An IC may be, for example, a microprocessor that accesses programming instructions or other data stored in a ROM and/or hardwired into the IC. For example, an IC may comprise an Application Specific Integrated Circuit (ASIC) having gates and/or other logic dedicated to the calculations and other operations described herein. An IC may perform some operations based on execution of programming instructions read from ROM or RAM, with other operations hardwired into gates or other logic. Further, an IC may be configured to output image data to a display buffer.

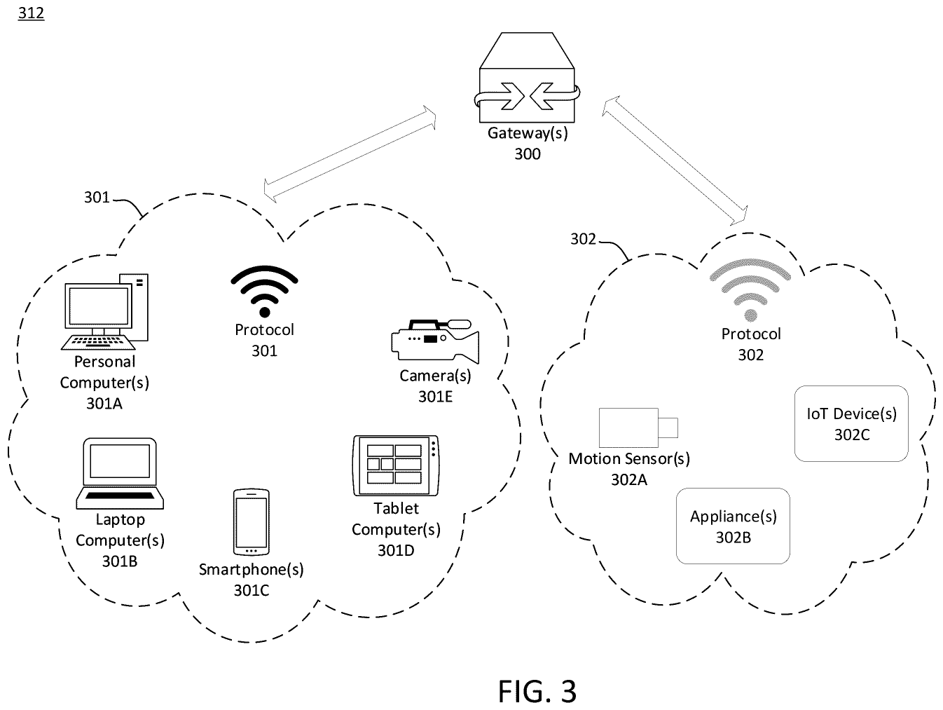

FIG. 3 shows an example environment 312 comprising devices transmitting across various wireless protocols. The environment 312 may be any of the premises 102, such as example premises 102a. A gateway 300 may facilitate communications between various wireless protocols. The gateway 300 may be implemented by the gateway 111. Transmissions across example standard-power wireless protocol 301 and example low-power wireless protocol 302 may be facilitated by the gateway 300. The standard-power protocol 301 may be a comparatively high-power, high-bandwidth wireless protocol with more stable frequencies, for example, WiFi and/or others. The low-power protocol 302 may be a comparatively low-power, low-bandwidth wireless protocol with less stable frequencies, for example, one or more of ZigBee, Matter, Bluetooth, Bluetooth Low Energy (BLE), Z-Wave, 6LoWPAN, etc. The standard-power protocol 301 and the low-power protocol 302 may transmit across the same channels. Devices communicating via the standard-power protocol 301 may comprise personal computers 301A, laptop computers 301B, smartphones 301C, tablet computers 301D, cameras 301E, and/or other devices. Devices communicating via the low-power protocol 302 may comprise motion sensors 302A, appliances 302B, Internet-of-Things (IoT) devices 302C, and/or other devices. The gateway 300, the standard-power protocol 301, the low-power protocol 302, the devices 301A-C, and/or the devices 302A-C may be in a single premises (e.g., public and/or private premises, multi-dwelling premises, etc.) and/or across multiple premises.

Packet traffic arbitration (PTA) allows for coexistence of multiple wireless communications. In some implementations, PTA comprises prioritizing one or more wireless communications over another wireless communication. For example, in such implementations, a higher power, higher bandwidth communication protocol such as WiFi may dominate communication resources over a lower power, lower bandwidth communication protocol such as ZigBee. In addition, PTA mechanisms may implement resource arbitration procedures, for example, at the medium access control (MAC) layer, to determine which packets should be prioritized in receiving communication resources (e.g., bandwidth, etc.).

A problem can exist in at least some implementations of PTA environments (e.g., environment 312) where two or more wireless protocols exist in the vicinity of each other (e.g., standard-power protocol 301 and low-power protocol 302). In these situations, the ability of one of the protocols (e.g., low-power protocol 302) to transmit may be hindered by the transmit power levels of a dominant radio (e.g., those of standard-power protocol 301 devices). Additional noise introduced by other electronic devices (e.g., EMI) or environmental (e.g., temperature/thermal) and mechanical (e.g., reflection due to shielding, heatsinks, etc.) may also contribute to adverse variables for a lesser powered radio (e.g., the low-power protocol 302) to transmit effectively. Another problem is that acknowledgements of transmissions may be suppressed due to noise issues, which has the effect of causing (in some instances) peripheral devices such as the devices 301A-301E and/or 302A-302C to generate unnecessary retries. These additional and unnecessary retries may increase latency and reduce battery lifespan. Combinations of available coexistence mechanisms may improve the ability for secondary protocols such as low-power protocols to transmit and receive, the impact to WiFi may be fairly significant. WiFi impact may be minimized by enhancing the PTA mechanism as described herein.

The gateway 300 may facilitate transmissions from various devices (e.g., devices 301A-E and/or 302A-C) across multiple frequencies, for example standard-power protocols 301 and low-power protocols 302. Communication with the difference frequencies/protocols (e.g., 301 and 302) can require different treatment, however. For example, some low-power protocols 302 may be less adaptive, remaining on the same wireless channel along which they began transmitting even in even when traffic conditions increase (e.g., when high power WiFi transmissions occur on the same channel). In such instances, transmissions from devices such as the devices 302A-302C (e.g., transmissions from IoT devices such as motion sensors, door sensors, window sensors, etc.) may experience a high retry rate, yielding unfavorable effects to battery life. Even with higher transmit power levels on the sensors that addresses upstream transmission to the gateway 300 (e.g., a WiFi router, etc.), the downstream transmissions from the gateway to the sensors may be affected by the presence of multiple wireless protocols operating in the same 2.4 GHZ ISM spectrum. For example, in limited operating space, the less adaptive nature of some low-power protocols (e.g., ZigBee) may be affected by WiFi when it is transmitting. These low-power protocols may tend to back off after sensing and continue to randomly do so when it is unable to find a clear path due to concurrent low-power protocol and standard-power protocol transmission.

PTA may be enabled, for example, by the gateway 300, to ensure a clear path for when a low-power protocol (e.g., protocol 302) intends to transmit. Some implementations of PTA (e.g., PTA with pulse width modulation (PWM)) may affect standard-power protocol (e.g., WiFi) transmission by prioritizing a low-power protocol (e.g., protocol 302) almost instantaneously. This may be due to the hardware implementation of the high priority pin being hardwired directly into the WiFi chipset. As gateway standards evolve to support higher modulation rates efficiently—the ability to do so in a Time Domain based system—packets are aggregated at the MAC layer and then transmitted. The MAC layer manages communications between various entities, including aggregating packets. Aggregating packets into a single transmission unit, called the Aggregated MAC Service Data Unit (AMSDU), is available and enabled in the 802.11ax IEEE standards. Some implementations of PTA may struggle with distinguishing between any levels of AMSDU (e.g., units of aggregated WiFi packets) and may impair performance of WiFi and/or other wireless protocols. For example, if a large set of packets is queued and interrupted by PTA when a low-power protocol needs to transmit to certain sensors, WiFi may experience severe cyclic redundancy check (CRC) errors, which may lead to more noticeable latency and disassociation of WiFi clients.

An intelligent PTA mechanism—solving the problems of the low-power protocols without hindering standard-power protocols such as WiFi is disclosed herein. In such intelligent PTA systems, PTA may be selectively enabled and disabled based on certain criteria. For example, other variables may be taken into consideration to account for when AMSDU reaches a certain threshold that may result in severe latency and significant retries. The variables may include signal-to-noise ratios (SNR), received signal strength indicator (RSSI) levels, AMSDU queue sizes, modulation coding scheme (MCS) rates, schedules, device types, user profiles, and/or other variables. Intelligent PTA may be applied using different modes of operation based on various operating parameters, for example, PTA may be variously implemented in a small house, a large house, a multi-unit dwelling, a public location, and/or others.

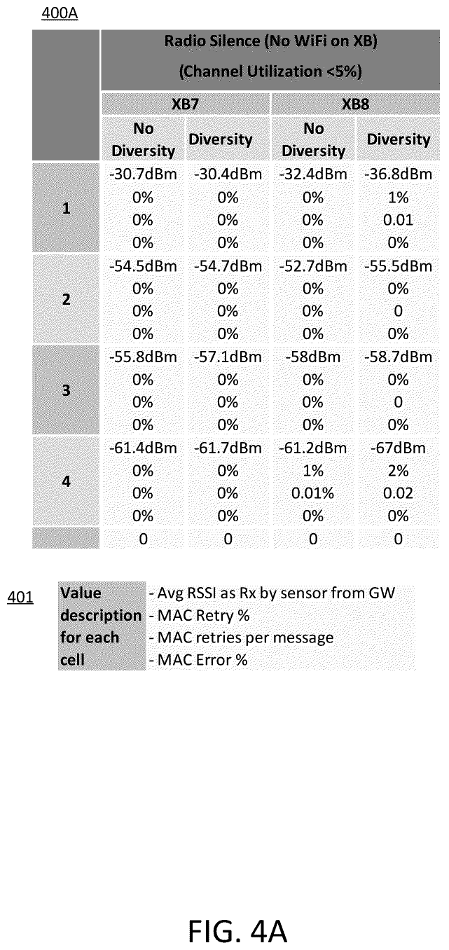

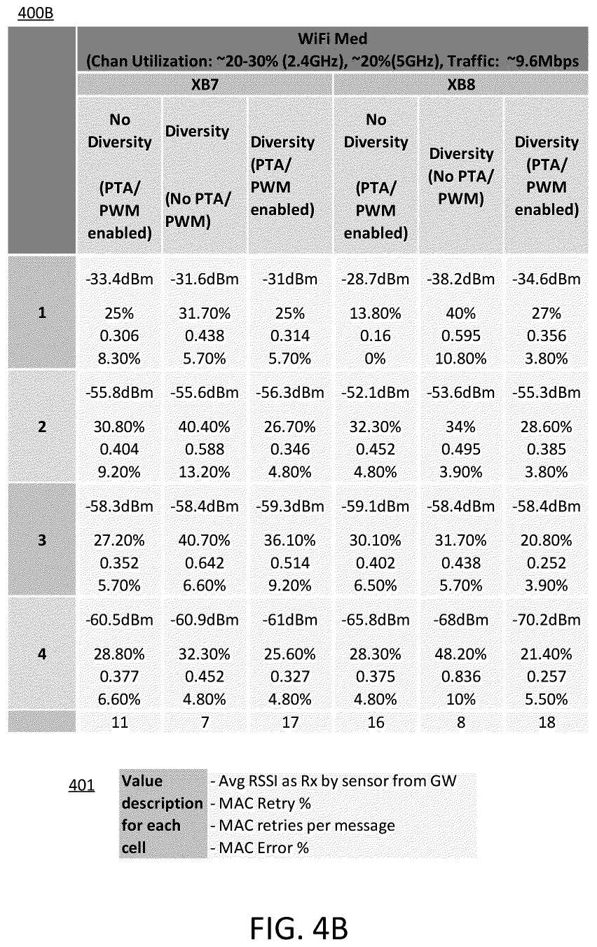

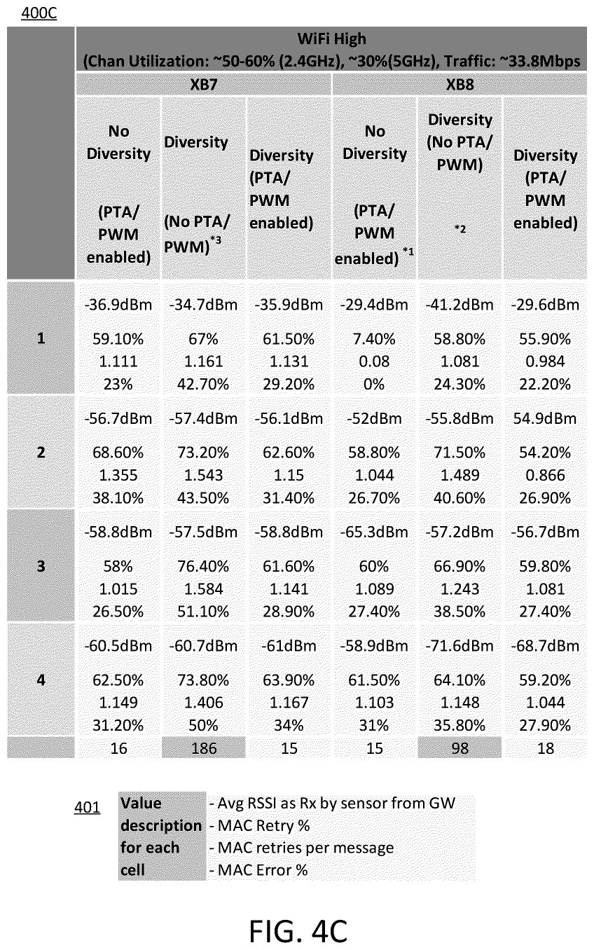

FIGS. 4A-4C are thirds of a large table showing example results of enabling packet traffic arbitration. The tables were generated based on trials aiming to quantify usability of ZigBee radio and impacts to WiFi on some gateways (e.g., XB7 and XB8 Comcast gateways) given PTA/PWM and antenna diversity features when operating at different intervals/duty cycles and antenna configurations, respectively, in various environments. When PTA/PWM is applied, even to transmissions via more advanced gateways, standard-power transmissions (e.g., WiFi) may experience latency and WiFi devices may disassociate due to the prioritization of the low-power protocol (e.g., Zigbee). Therefore, utilization of intelligent PTA may allow for improved WiFi performance during prioritization of low-power transmissions. In FIGS. 4A-4C, table 401 shows a legend describing the values in each results cell. The results cells contain the four following values: average RSSI as received by a sensor from the gateway; MAC retry percentage; MAC retries per message; and MAC error percentage. FIG. 4A shows table 400A, showing results for XB7 and XB8 gateways with no WiFi and channel utilization below 5%. FIG. 4B shows table 400B, showing results for XB7 and XB8 gateways in a medium utilized WiFi environment and the following channel utilization: ˜ 20-30% (2.4 GHz), ˜20% (5 GHz); and ˜9.6 Mbps traffic at 2.4/5 GHz. FIG. 4C shows table 400C, showing results for XB7 and XB8 gateways in a highly utilized WiFi environment and the following channel utilization: ˜ 50-60% (2.4 GHz), ˜30% (5 GHz); and ˜33.8 Mbps (2.4 GHz) and 37 Mbps (5 GHz) traffic. The measurements yielded the following results. XB8 with Diversity and PTA/PWM enabled performed slightly better than XB7 for mid to far locations in a medium utilized WiFi environment. XB8 with Diversity and PTA/PWM enabled performs slightly better than XB7 in a highly utilized WiFi environment. Battery consumption is negligible when diversity and PTA/PWM is enabled in comparison with no diversity. Latency is negligible when diversity and PTA/PWM is enabled in comparison with no diversity.

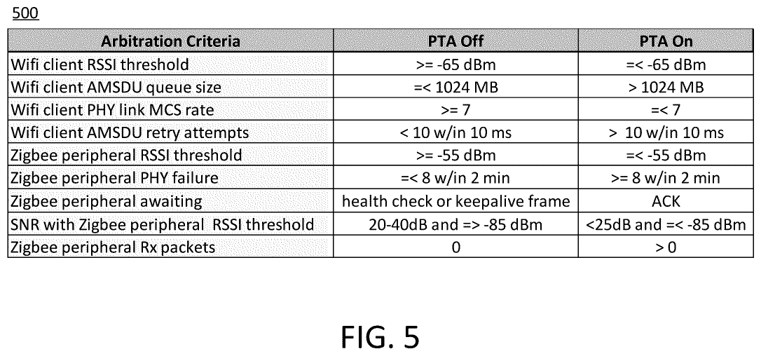

FIG. 5 is a table 500 showing example criteria for enabling packet traffic arbitration corresponding to the below formula. While specific numbers have been entered into the table, these are only to ease explanation and it should be understood that this disclosure is not limited to the specific values entered into the various cells of table 500. In FIG. 5's example, consider a scenario where the standard power protocol (i.e., protocol 301 from FIG. 3) is WiFi and the low-power protocol (e.g., protocol 302 from FIG. 3) is ZigBee. In this scenario, these criteria and/or others, may be represented and/or weighted using the following formula:

$$\\ \begin{matrix}f ( c ) = w ( r ) + w ( am ) + w ( mcs ) + \frac{w ( ra )}{{t}_{1}} + z ( r ) + \frac{z ( cca )}{{t}_{2}} + z ( pkt ) + s ( n ) + r ( 1 ) , & ( Eq . 1 )\end{matrix}$$

where
f(c) is a value for determining whether to enable PTA based on weighting predetermined variables,
w(r) is the RSSI level of the WiFi client,
w(am) is the AMSDU queue size of the WiFi client,
w(mcs) is the MCS rate of the physical layer (PHY) link of the WiFi client,
w(ra)/t1 is an AMSDU retry attempt of the WiFi client over time,
z(r) is an RSSI level of the ZigBee peripheral,
z(cca)/t2 is a ccaFailure count of the ZigBee peripheral over time,
z(pkt) is a packet type being transmitted to the ZigBee peripheral,
s(n) is a signal-to-noise ratio (SNR), and
r(1) is the RSSI value for the ZigBee peripheral as seen by a gateway.

The preceding formula is shown by way of example and is not intended to be limiting. The listed variables and/or others may be considered and/or weighted using a similar formula and/or other methods. The weighting may be implemented by the gateway 300, the criteria server 122, cloud servers, and/or other devices. Additionally, the weighting may be variable. The formula, for example, may change such that the factors may be variously weighted. The sum of variables, quantity f(c), will determine what the weighting value is. For example, the AMSDU variable may carry more ‘weight’ or priority and the larger the queue size, the higher the sum f(c) would be. Based on that notion, the algorithm may elect to either enable PTA before the overall weighting value increases, or it may focus on certain variables (e.g., AMSDU and RSSI, etc.). In this case, for example, if AMSDU is high but WiFi client RSSI is low, that may indicate that the client may be going out of range from the router and the packets are queueing up and may experience a higher level of failure if PTA is enabled. Based on this logic, PTA may be disabled more quickly. In the case where AMSDU may be lower, and ZigBee client RSSI is higher, then weighting algorithm may elect to focus on the AMSDU variable as the determining ‘weight’ and hold off on initiating PTA as there may not be as many packets queued, correlating to low activity, and in turn, lower priority for WiFi to be interrupted. For example, most applications have a certain level of data that are constantly being transmitted, whether it's a keepalive, or some active poll inquiry. At a basic level, an email application may consume approximately 25 kbps of data when idle. If AMSDU queue does not even exceed 1 MB, for example, then then the email application may be categorized as idle and PTA may not be enabled.

Based on the results of such calculations, PTA may be enabled such that network resources including bandwidth may be reallocated as to prioritize certain transmissions accordingly. For example, ZigBee transmissions from certain devices (e.g., thermostats, refrigerators, and/or devices which may be deemed “secondary”) may be suppressed in favor of transmissions from other devices which may be deemed “primary” (e.g., security devices, motion sensors, door sensors, window sensors, etc.). Bandwidth and other network resources may be reallocated to prioritize the “primary” devices. If these reallocations occur based on the weighted criteria (including considerations of schedules, priority profiles, etc. as described below), for example, impacts on WiFi may be decreased and overall transmissions may be optimized. PTA may be disabled, for example, if connection to a WiFi client is weak (e.g., determined based on a WiFi client RSSI value below a predetermined threshold) in order to prioritize WiFi communications over lower power, lower bandwidth communications, for example, from IoT devices.

The values in the table are shown by way of example only and are not intended to be limiting. For example, the WiFi client RSSI threshold for enabling PTA may be −50 dBm, and the WiFi client PHY link MCS rate threshold for enabling PTA may be less than or equal to 6. Similar logic may be applied to the other variables.

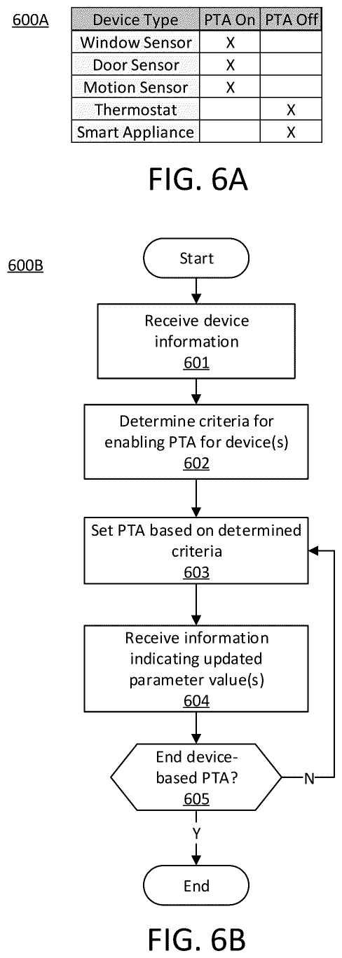

FIGS. 6A, 7A, and 8A show example tables for implementing packet traffic arbitration based on various criteria. The data in FIGS. 6A, 7A, and 8A may be considered in combination with the data in FIG. 5. The criteria in FIGS. 5, 6A, 7A, and 8A may be configured automatically and/or by users.

FIG. 6A is a table 600A showing example criteria for enabling packet traffic arbitration based on devices. For example, PTA may be set to be enabled for certain devices communicating across the low-power protocol 302. In the table 600A, for example, PTA may be selected to be enabled for window sensors, door sensors, motion sensors, and/or other devices. PTA may be selected to be disabled for thermostats and smart appliances. Users may wish to enable PTA for certain devices and/or device types, for example, devices deemed to be “essential” such as security devices. Smart PTA may be implemented to prioritize some devices and/or device types. For example, it may be useful to divide transmission resources between devices. Some devices and/or device types may be may be labeled as “essential”, such as security devices. Users may find it more advantageous to decrease latency and keep consistent communication for such types of devices (e.g., security devices). A user may wish to use PTA to prioritize communications from one or more types of devices, for example, a door sensor, over other types of devices, for example, a smart refrigerator.

FIG. 6B is a flow chart showing an example method 600B for packet traffic arbitration based on devices. At 601, device information may be received. For example, the gateway 300 may receive information indicating a device's identifier (e.g., MAC address, etc.), device type (e.g., appliances, security devices, personal computers, etc.), and/or other qualities. At 602, criteria for enabling PTA may be determined. For example, the gateway 300 may retrieve (e.g., from the criteria server 122) information indicating criteria for enabling PTA based on devices and/or device types. At 603, PTA may be set based on the determined criteria (e.g., by the gateway 300). For example, PTA may be set to be enabled for security devices (such as window sensors, door sensors, and motion sensors). PTA may be set to be enabled for security devices, for example, at lower thresholds than other devices. PTA may be set to be disabled based on device types and/or specific devices, for example, PTA may be set to be disabled for a thermostat. In this scenario, standard-power protocol communication may be set to be prioritized over thermostat communications. Network resources may be reallocated based on the setting to enable or disable PTA. At 604, information indicating updated parameter values may be received. For example, AMSDU queue sizes may decrease, and the updated values may be used to determine to disable PTA. At 605, a determination may be made as to whether the device-based PTA mechanism should be stopped. In the case of a “No” determination, at 603, PTA may be set based on the determined criteria and/or updated parameter values.

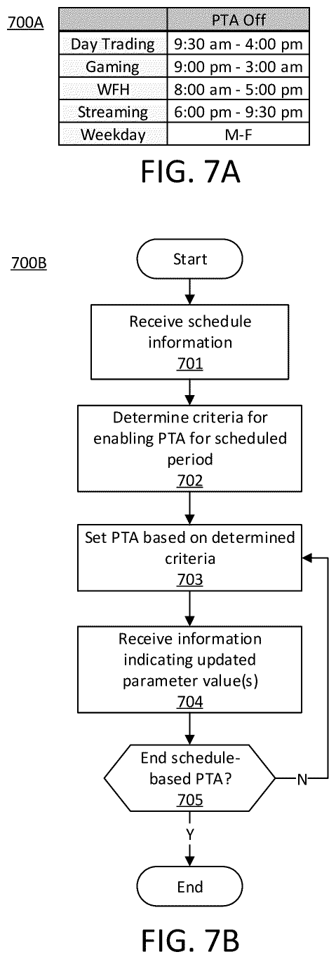

FIG. 7A is a table 700A showing example criteria for enabling packet traffic arbitration based on schedules. Similar to the logic of FIG. 6A, PTA may be configured based on considering the variables shown in table 700A of FIG. 7A. In the table 700A, for example, PTA may be selected to be enabled during certain schedules, which may be variable and/or predetermined. Certain users and/or user profiles, for example, such as day trading, gaming, working from home (WFH), streaming, weekdays, and/or others may experience enhanced performance if PTA is applied intelligently. For example, for a weekday-schedule-based intelligent PTA mechanism, PTA may be enabled on weekdays (e.g., when users are out and security devices are prioritized) and disabled on weekends (e.g., when more users are home and using internet-connected devices). Data related to users, user schedules, user profiles, and/or other user information may be stored in the account server 123. For a WFH user, for example, the intelligent PTA mechanism may be applied to limit WiFi interruptions and slowdowns during predetermined working hours. The scheduling factor may be considered in combination with the device types of FIG. 6A and/or the variables of FIG. 5 in order to implement optimized intelligent PTA based on the user's needs.

FIG. 7B is a flow chart showing an example method 700B for packet traffic arbitration based on schedules. At 701, schedule information may be received. For example, the gateway 300 may receive information indicating a schedule for setting PTA (e.g., a day trading schedule may set PTA to be disabled from 9:30 am-4:00 pm, etc.). At 702, criteria for enabling PTA may be determined. For example, the gateway 300 may retrieve (e.g., from the criteria server 122) information indicating criteria for enabling PTA based on the received schedule information. At 703, PTA may be set based on the determined criteria (e.g., by the gateway 300). For example, PTA may be set to be enabled on a “streaming” schedule, such that it is disabled from 6:00 pm-9:30 μm. The schedules may be variable, for example, users may modify schedules at any time. Network resources may be reallocated based on the setting to enable or disable PTA. In this scenario, for example, network resources may be reallocated to devices using the low-power protocol (e.g., protocol 302) during all hours except the indicated “streaming” time. At 704, information indicating updated parameter values may be received. For example, MAC retry rates may decrease, and the updated values may be used to determine to disable PTA. At 705, a determination may be made as to whether the schedule-based PTA mechanism should be stopped. In the case of a “No” determination, at 703, PTA may be set based on the determined criteria and/or updated parameter values.

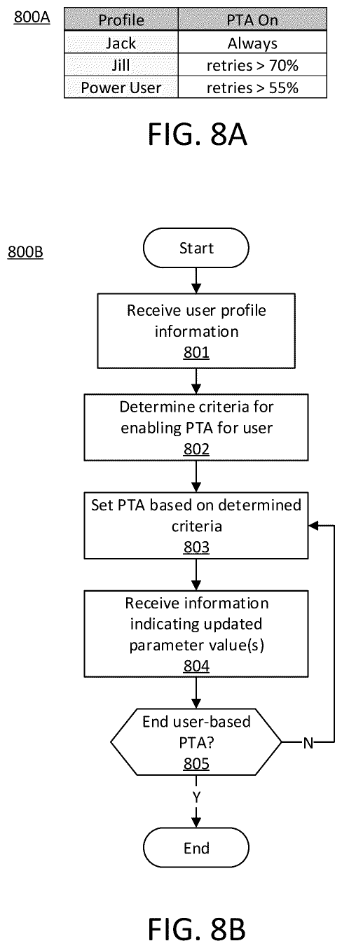

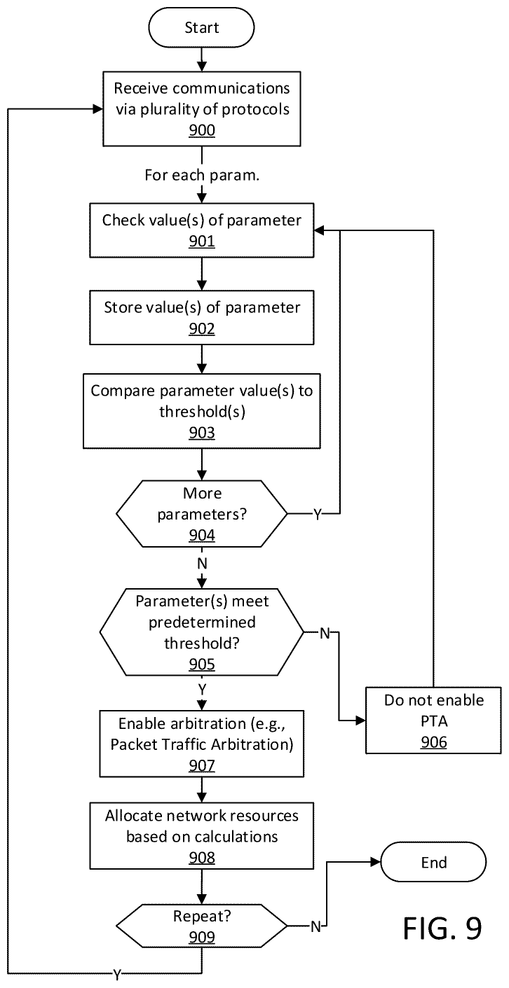

FIG. 8A is a table 800A showing example criteria for enabling packet traffic arbitration based on user profiles. Similar to the logic of FIG. 7A, PTA may be considered based on considering the variables shown in table 800A of FIG. 8A. Certain users and/or user profiles, for example, may be selected to experience enhanced performance if PTA is applied intelligently. In the table 800A, PTA may be enabled during Jill's internet usage when one or more variables reach a predetermined threshold, for example, if the MAC retry percentage exceeds 70%. Jill may be considered a “priority” user, and PTA may be set to be disabled during her use if, for example, the MAC retry percentage exceeds 70%. For a user such as a power user, for example, PTA may be set to be enabled when one or more variables reach a predetermined threshold (e.g., if the MAC retry percentage exceeds 55%, the AMSDU queue size exceeds 1024 MB, and/or others, etc.). Similarly, PTA may be set to be enabled at all times regardless of Jack's internet usage, for example, if devices using the low-power protocol are considered “essential” are prioritized during Jack's internet usage. The user profile factor may be considered in combination with the device types of FIG. 6A, the schedules of FIG. 7A, and/or the variables of FIG. 5 in order to implement optimized intelligent PTA based on users' needs.

FIG. 8B is a flow chart showing an example method 800B for packet traffic arbitration based on user profiles. At 801, user profile information may be received. For example, the gateway 300 may receive information indicating how to enable PTA based on user profiles (e.g., based on parameters reaching various predetermined thresholds for various users, etc.). At 802, criteria for enabling PTA may be determined. For example, the gateway 300 may retrieve (e.g., from the criteria server 122) information indicating criteria for enabling PTA based on users and/or user profiles. At 803, PTA may be set based on the determined criteria (e.g., by the gateway 300). For example, PTA may be set to be enabled for a user, such as a power user. In this scenario, PTA may be set to be enabled for a high usage, for example, at lower thresholds than for other users (e.g., PTA may be enabled during high usage of the standard-power protocol 301 for retries exceeding 55%). Network resources may be reallocated based on the setting to enable or disable PTA. At 804, information indicating updated parameter values may be received. For example, AMSDU queue sizes may decrease, and the updated values may be used to determine to disable PTA. At 805, a determination may be made as to whether the user-profile-based PTA mechanism should be stopped. In the case of a “No” determination, at 803, PTA may be set based on the determined criteria and/or updated parameter values.

FIGS. 9-11 are flow charts showing example methods for intelligent packet traffic arbitration. The methods of FIGS. 9-11 may be implemented by any devices described herein. The methods of FIGS. 9-11 may be implemented by machine learning algorithms.

FIG. 9 is a flow chart showing an example method for intelligent packet traffic arbitration. At 900, communications via a plurality of protocols may be received. For example, a gateway such as the gateway 300 may receive communications via a plurality of wireless protocols, such as the standard-power protocol 301 and the low-power protocol 302. At 901, for each predetermined parameter, such as the variables of FIGS. 5, 6A, 7A, and 8A, the values of the parameters may be determined. At 902, the values of the parameter may be stored, for example, by the criteria server 122 and/or the gateway 300. At 903 the parameter value may be compared to thresholds, which may be predetermined and/or variable. At 904, a determination may be made as to whether more parameter values should be determined. In the case of a “Yes” determination, 901 may be implemented again. This loop may continue until a “No” determination at 904. At 905, a determination may be made as to whether the combined parameters meet the predetermined and/or variable thresholds. For example, the values of the parameter may be weighted using the Eq. 1 (e.g., by the gateway 300, the criteria server 122, and/or other devices), and the resulting quantity f(c) may be used to determine whether PTA should be enabled. In the case of a “No” determination, at 906, a PTA may be set to be disabled. PTA may be temporarily halted or prevented from implementation, for example, until a “Yes” determination at 905. In the case of a “Yes” determination, at 907 an arbitration mechanism may be enabled. For example, PTA may be enabled. At 908, network resources may be allocated in implementing intelligent PTA. For example, bandwidth for transmissions across the protocol 302 may be reallocated from lower-priority devices such as the appliances 302B and/or the IoT devices 302C to higher-priority devices such as the motion sensors 302A while reducing latency and interruptions to the devices 301A-301E transmitting using the standard-power protocol 301. This reallocation may be varied based on ongoing measurements and/or calculations. At 909, a determination may be made as to whether to repeat the process. For example, the method of FIG. 9 may be repeated continuously in order to variably apply intelligent PTA for optimized performance across devices and/or wireless protocols.

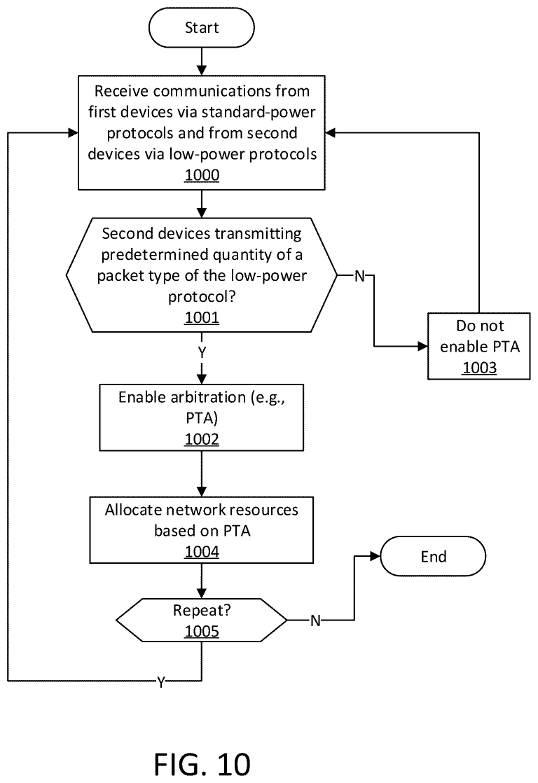

FIG. 10 is a flow chart showing an example method for intelligent packet traffic arbitration. An intelligent arbitration mechanism, such as intelligent packet traffic arbitration, may determine whether to enable arbitration, for example, based on a predetermined number of packets being transmitted by a device using a low-power protocol. For example, a motion sensor may transmit using ZigBee. PTA may be enabled for the motion sensor, for example, if the motion sensor receive (Rx) packets are greater than zero (such as shown in FIG. 5). Intelligently determining to enable PTA based on a predetermined threshold for a packet type, such as Rx packets, may allow for improved communication for the device using the low-power protocol, for example, if PTA is enabled for some devices using the low-power protocol and not others. At 1000, communications may be received, from first devices using a standard-power protocol and from second devices using a low-power protocol. For example, a wireless gateway such as the gateway 300 may receive communications. At 1001, a determination may be made as to whether the second devices are transmitting a predetermined quantity of a packet type of the low-power protocol. For example, the gateway 300 may determine whether it is receiving any transmit packets form the second devices using the low-power protocol. In the case of a “Yes” determination, at 1002 an arbitration mechanism may be enabled. For example, PTA may be enabled. In the case of a “No” determination, at 1003, PTA may not be enabled. For example, PTA may be set to be disabled. At 1004, network resources may be allocated in implementing intelligent PTA. For example, bandwidth for transmissions across the protocol 302 may be reallocated from lower-priority devices such as the appliances 302B and/or the IoT devices 302C to higher-priority devices such as the motion sensors 302A while reducing latency and interruptions to the devices 301A-301E transmitting using the standard-power protocol 301. This reallocation may be varied based on ongoing measurements and/or calculations. At 1005, a determination may be made as to whether to repeat the process. For example, the method of FIG. 10 may be repeated continuously in order to variably apply intelligent PTA for optimized performance across devices and/or wireless protocols.

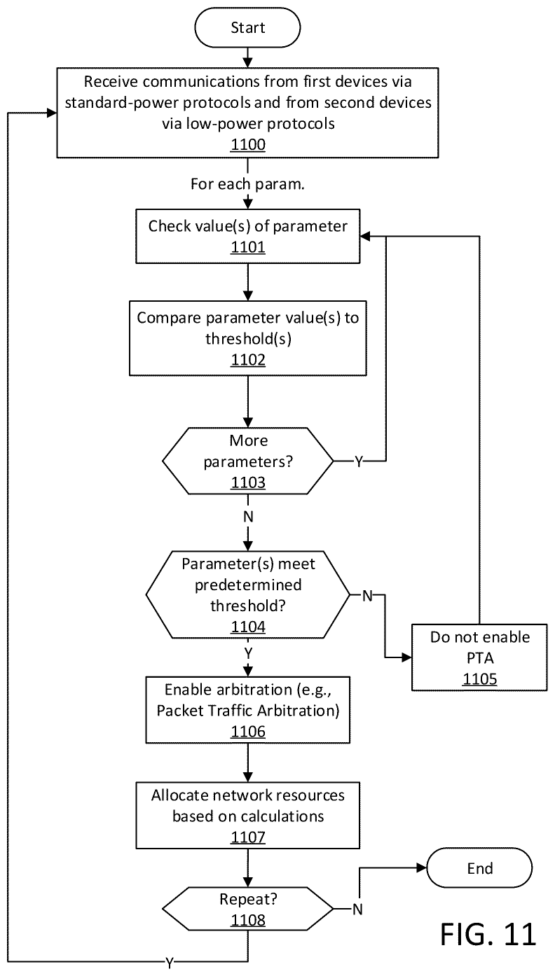

FIG. 11 is a flow chart showing an example method for intelligent packet traffic arbitration. At 1100, communications may be received, from first devices using a standard-power protocol such as WiFi and from second devices using a low-power protocol such as ZigBee. For example, a wireless gateway such as the gateway 300 may receive communications. At 1101, for each predetermined parameter, such as the variables of FIGS. 5, 6A, 7A, and 8A, the values of the parameters may be determined. For example, the values may be stored by the criteria server 122 and/or the gateway 300. At 1102 the parameter value may be compared to thresholds, which may be predetermined and/or variable. At 1103, a determination may be made as to whether more parameter values should be determined. In the case of a “Yes” determination, 1101 may be implemented again. This loop may continue until a “No” determination at 1103. At 1104, a determination may be made as to whether the combined parameters meet the predetermined and/or variable thresholds. For example, the values of the parameter may be weighted using the Eq. 1 (e.g., by the gateway 300, the criteria server 122, and/or other devices), and the resulting quantity f(c) may be used to determine whether PTA should be enabled. In the case of a “No” determination, at 1105, a PTA may be set to be disabled. PTA may be temporarily halted or prevented from implementation, for example, until a “Yes” determination at 1104. In the case of a “Yes” determination, at 1106 an arbitration mechanism may be enabled. For example, PTA may be enabled. At 1107, network resources may be allocated in implementing intelligent PTA. For example, bandwidth for transmissions across the protocol 302 (e.g., ZigBee) may be reallocated from lower-priority devices such as the appliances 302B and/or the IoT devices 302C to higher-priority devices such as the motion sensors 302A while reducing latency and interruptions to the devices 301A-301E transmitting using the standard-power protocol 301. This reallocation may be varied based on ongoing measurements and/or calculations. For example, PTA may be enabled selectively for some ZigBee devices based on various criteria. When considering schedules, for example, PTA may be disabled for a predetermined duration (e.g., the workday) for a WFH schedule. Transmission resources may thus be reallocated for devices transmitting via WiFi, for example, which may decrease latency and improve efficiency for users working from home. At 1108, a determination may be made as to whether to repeat the process. For example, the method of FIG. 11 may be repeated continuously in order to variably apply intelligent PTA for optimized performance across devices and/or wireless protocols.

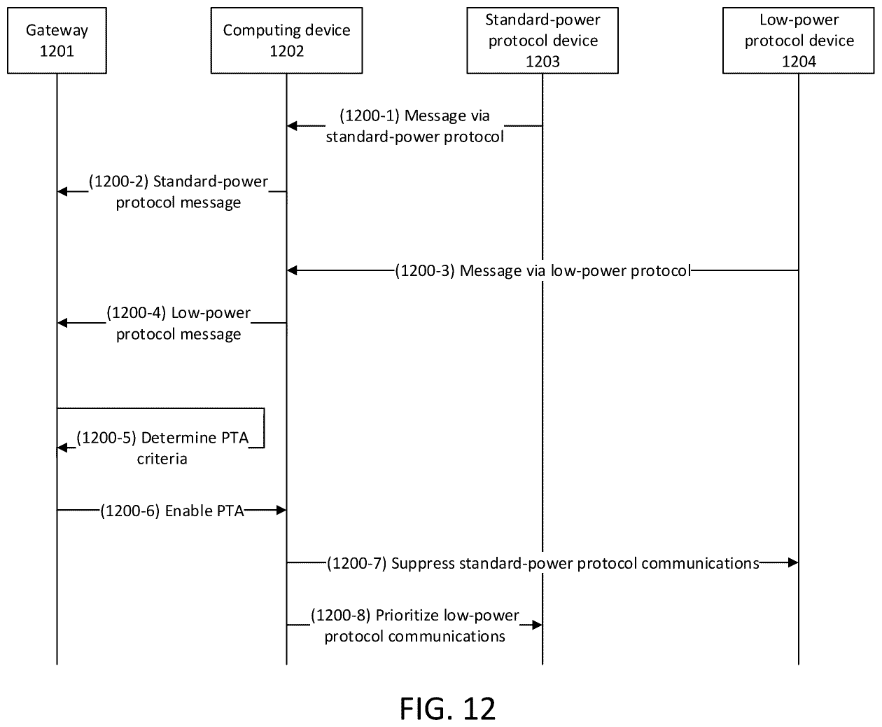

FIG. 12 is a sequence diagram showing example communications between a gateway and devices using various wireless protocols. For example, devices of the environment 312 of FIG. 3 may communicate using the example sequence of FIG. 12. The devices of FIG. 12 may include a gateway 1201 (e.g., the gateway 300), a computing device 1202, a standard-power protocol device 1203 (e.g., the smartphone 301C), and a low-power protocol device 1204 (e.g., the motion sensor 302A). The computing device 1202 may be an intermediary computing device at which the methods of FIGS. 9-11 may be implemented. The communications of FIG. 12 may occur directly between the devices 1203-1204 and the gateway 1201. At 1200-1, the standard-power protocol device 1203 may attempt to send a message using a standard-power protocol (e.g., protocol 301). The computing device 1202 may receive the message and, at 1200-2, may transmit the message to the gateway 1201. At 1200-3, the low-power protocol device 1204 may attempt to send a message using a low-power protocol (e.g., protocol 302). The computing device 1202 may receive the message and, at 1200-4, may transmit the message to the gateway 1201. At 1200-5, the gateway 1201 may determine criteria for enabling or disabling PTA. At 1200-6, the gateway 1201 may determine to intelligently enable PTA. Also or alternatively, 1200-5 and/or 1200-6 may be implemented by the computing device 1202. The computing device 1202 may enable PTA, for example, suppressing the standard-power transmissions at 1200-7 and prioritizing the low-power protocol transmissions at 1200-8. Also or alternatively, the gateway 1201 may implement 1200-7 and/or 1200-8.

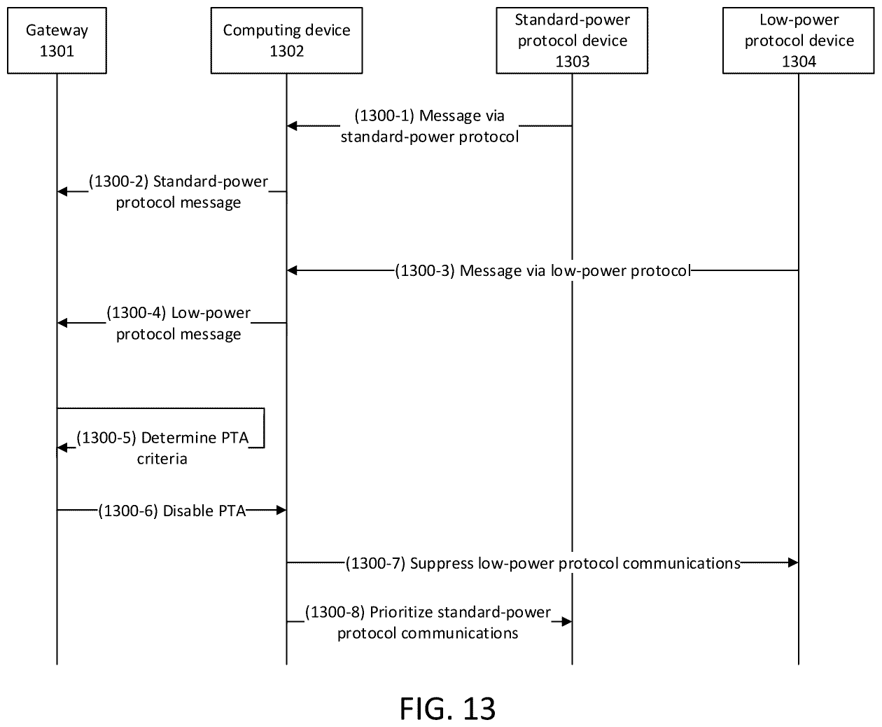

FIG. 13 is a sequence diagram showing example communications between a gateway and devices using various wireless protocols. In some situations, transmissions using a standard-power protocol, such as WiFi, may experience latency (e.g., if a user is gaming). In these cases, it can be desirable or advantageous to prioritize standard-power transmissions such as WiFi, by intelligently disabling PTA, thus improving WiFi speeds and decreasing latency. For example, devices of the environment 312 of FIG. 3 may communicate using the example sequence of FIG. 13. The devices of FIG. 13 may include a gateway 1301 (e.g., the gateway 300), a computing device 1302, a standard-power protocol device 1303 (e.g., the smartphone 301C using WiFi), and a low-power protocol device 1304 (e.g., the motion sensor 302A using ZigBee). The computing device 1302 may be an intermediary computing device at which the methods of FIGS. 9-11 may be implemented. The communications of FIG. 13 may occur directly between the devices 1303-1304 and the gateway 1301. At 1300-1, the standard-power protocol device 1303 may attempt to send a message using a standard-power protocol (e.g., protocol 301). The computing device 1302 may receive the message and, at 1300-2, may transmit the message to the gateway 1301. At 1300-3, the low-power protocol device 1304 may attempt to send a message using a low-power protocol (e.g., protocol 302). The computing device 1302 may receive the message and, at 1300-4, may transmit the message to the gateway 1301. At 1300-5, the gateway 1301 may determine criteria for enabling or disabling PTA. At 1300-6, the gateway 1301 may determine to disable PTA. Also or alternatively, 1300-5 and/or 1300-6 may be implemented by the computing device 1302. The computing device 1302 may enable PTA, for example, suppressing the low-power transmissions at 1300-7 and prioritizing the standard-power protocol transmissions at 1300-8. Also or alternatively, the gateway 1301 may implement 1300-7 and/or 1300-8. Advantages described herein, based on determining to disable PTA in favor of prioritizing standard-power communications, may include, for example, improving WiFi transmission speeds, decreasing latency, and improving user experience.

Although examples are described above, features and/or steps of those examples may be combined, divided, omitted, rearranged, revised, and/or augmented in any desired manner. Various alterations, modifications, and improvements will readily occur to those skilled in the art. Such alterations, modifications, and improvements are intended to be part of this description, though not expressly stated herein, and are intended to be within the spirit and scope of the disclosure. Accordingly, the foregoing description is by way of example only, and is not limiting.

1. A method comprising:
receiving, by a wireless gateway and from a first device, a first communication using a first protocol;
receiving, by the wireless gateway and from a second device, a second communication using a second protocol;
determining, based on the received first and second communications, values for one or more parameters relating to the first protocol and values for one or more parameters relating to the second protocol;
determining, based on the determined values for the one or more first parameters and the determined values for the one or more second parameters, that one of the first or second communication protocols should be prioritized; and
enabling, based on the determined values for the one or more first parameters and the determined values for the one or more second parameters, packet traffic arbitration (PTA), wherein the enabling PTA comprises reallocating transmission resources for one of the first or second communications.

2. The method of claim 1, wherein determining values for the one or more parameters relating to the first protocol comprises determining values for one or more of:
a data unit queue size associated with the first protocol;
a received signal strength indicator (RSSI) level associated with the first protocol;
a quantity of transmission success reports for the first protocol; and
a modulation coding scheme rate associated with the first protocol.

3. The method of claim 1, wherein determining values for the one or more parameters relating to the second protocol comprises determining a packet type associated with the second protocol.

4. The method of claim 1, wherein determining values for the one or more parameters relating to the second protocol comprises determining values for one or more of:
an RSSI level associated with the second protocol;
a quantity of transmission success reports for the second protocol; and
a signal to noise ratio.

5. The method of claim 1, wherein the second wireless protocol is associated with one or more of lower power consumption, lower bandwidth, and less stable frequencies when compared to the first wireless protocol.

6. The method of claim 4, wherein the determining the RSSI levels associated with the second protocol further comprises determining, by the wireless gateway, RSSI levels associated with the second protocol.

7. The method of claim 4, wherein the quantity of transmission success reports for the first and second protocols further comprises a quantity of retransmission attempts associated with the first protocol, and a quantity of clear channel assessment failures associated with the second protocol.

8. The method of claim 1, wherein the determining to enable the use of PTA further comprises determining that a predetermined threshold is satisfied based on the determined values.

9. The method of claim 1, further comprising determining, based on receiving updated values for the parameters, to disable the use of PTA.

10. The method of claim 9, wherein after PTA is disabled, PTA remains enabled for one or more essential devices.

11. The method of claim 1, further comprising determining, based on receiving, from the second device, a predetermined quantity of the packet type associated with the second protocol, to stop using PTA.

12. The method of claim 1, wherein the receiving further comprises receiving, by a second wireless gateway in a second premises, the one or more first communications and the one or more second communications; and
wherein the determining to enable the use of packet traffic arbitration further comprises determining, by the second wireless gateway, to use PTA.

13. The method of claim 1, wherein the determining to enable the use of PTA further comprises determining a quantity of acknowledgement packet types associated with the second protocol.

14. The method of claim 1, further comprising determining, based on the determining to enable the use of PTA, an updated quantity of retransmission attempts associated with the first protocol.

15. A method comprising:
receiving, by a wireless gateway and from a first device, a first communication using a first protocol;
receiving, by the wireless gateway and from a second device, a second communication using a second protocol;
determining, based on the received first and second communications, values for one or more parameters relating to the first protocol and values for one or more parameters relating to the second protocol;
determining, based on the determined values for the one or more first parameters and the determined values for the one or more second parameters, that the first communication protocol should be prioritized; and
disabling, based on the determining that the first communication protocol should be prioritized, packet traffic arbitration (PTA), wherein the disabling PTA comprises reallocating transmission resources for the first communication.

16. The method of claim 15, further comprising determining the plurality of values comprising:
a data unit queue size associated with the first protocol,
a modulation coding scheme rate associated with the first protocol,
received signal strength indicator (RSSI) levels associated with the first and second protocols,
a quantity of retransmission attempts associated with the first protocol,
a quantity of clear channel assessment failures associated with the second protocol,
a packet type associated with the second protocol, and
a signal to noise ratio.

17. The method of claim 15, wherein disabling PTA is further based on determining that a predetermined threshold is satisfied by the determined values.

18. A method comprising:
receiving, by a wireless gateway configured to receive via first and second wireless protocols, one or more first communications via the first wireless protocol from one or more first devices;
receiving, by the wireless gateway, one or more second communications via the second wireless protocol from one or more second devices; and
determining, based on the received one or more first communications and the received one or more second communications, and based on values for predetermined parameters, to communicate via the first protocol and the second protocol without packet traffic arbitration (PTA).

19. The method of claim 18, wherein the predetermined parameters comprise:
a data unit queue size associated with the first protocol,
a modulation coding scheme rate associated with the first protocol,
received signal strength indicator (RSSI) levels associated with the first and second protocols,
a quantity of retransmission attempts associated with the first protocol,
a quantity of clear channel assessment failures associated with the second protocol,
a packet type associated with the second protocol, and
a signal to noise ratio.

20. The method of claim 18, wherein the second wireless protocol is associated with one or more of lower power consumption, lower bandwidth, and less stable frequencies when compared with the first wireless protocol.
